(19) United States
(12) Patent Application Publication
(10) Pub. No.: US 2004/0190240 A1
(43) Pub. Date: Sep. 30, 2004

(54) Screwless fixing apparatus

(75) Inventor: Daniel Yeh, Taipei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Ever Case Technology Inc., Taipei City (TW)

(21) Appl. No.: 10/400,880

(22) Filed: Mar. 26, 2003

(51) Int. Cl. G06F 1/16

(52) U.S. Cl. 361/685

(57) ABSTRACT

The present invention provides a screwless fixing apparatus of the disk drive for quickly assembling and disassembling the disk drive without screws or other tools. When assembling the disk drive to the computer case, operate the screwless fixing apparatus of the present invention in open state. After the disk drive is in position, operate the controller components of the screwless fixing apparatus in close state and the disk drive can be fixed efficiently. When disassembling the disk drive, operate the controller components of the screwless fixing apparatus in open state, and the disk drive can be removed very simply.

### FIELD OF THE INVENTION

The present invention relates to a screwless fixing apparatus, and more particularly to a screwless fixing apparatus for fixing a disc drive having a plurality of standard threaded holes on two sides thereof in a computer case.

### BACKGROUND OF THE INVENTION

It is general to assemble the CD-ROM drive, soft disc or hard disc in the computer case with screws. Although the method has a precise and stable effect, a great quantity of manpower and material resource are consumed. Even the operator is practiced and careful, it is possible to drop the screws or other tools down and cause the damage of the computer components.

Now, some factories and stores have already used the slide track to fix the disc drive. However, the slide track is fixed to the disc drive or the computer case with screws and is unable to avoid the danger caused from the dropping tools, such as screws. Moreover, it is necessary to fix the sliding track to the both sides of the computer case and is more inconvenient to assemble or disassemble.

For solving the aforementioned problems, the objection of the present invention is to provide a screwless fixing apparatus for fixing the disk drive to the computer case. The present invention can fix the disk drive precisely and efficiently to the computer case on the premise of less cost and conveniently assembling and disassembling.

### SUMMARY OF THE INVENTION

It is an object of the present invention to provide a screwless fixing apparatus for fixing a disk drive having a plurality of threaded holes separately on its two sides to the computer case and to gain the well fixing effect. When installing the disk drive to the computer case, it only needs to operate the fastening switch of the screwless fixing apparatus in the open state. After the disk drive is set in its position, the switch is operated in the close state so that the disk drive can be fixed very efficiently. Similarly, when disassembling the disk drive, the fastening switch of the screwless fixing apparatus is operated in the open state, and then the disk drive can be take out easily.

It is another object of the present invention to provide a screwless fixing apparatus for fixing a disc drive having a plurality of standard threaded holes on two sides thereof in a computer case, which includes a frame for containing the disc drive, a plurality of elastic pieces mounted on a first side of the frame for respectively engaging with a plurality of standard threaded holes on the corresponding first side of the disc drive, a plurality of elastic protruding components mounted on a second opposite side of the frame for engaging with a plurality of standard threaded holes on the corresponding second side of the disc drive, and a plurality of controller components mounted separately outside of the plurality of elastic protruding components for controlling fastening switches of the elastic protruding components by means of rotating the controller components.

Preferably, the plurality of elastic pieces are combined with the frame by means of one of riveting and soldering.

Preferably, each of the elastic pieces further includes a folding tooth for engaging with the respective standard threaded hole.

Preferably, each of the elastic protruding components further includes a fastening part for engaging with the respective standard threaded hole.

Preferably, each of the plurality of elastic protruding components further includes a fastening switch for engaging with the plurality of standard threaded holes of the disc drive.

Preferably, each of the controller components further includes an axle center, a rotating piece and a protruding part.

Preferably, the protruding part presses the fastening part of the respective elastic protruding component to engage with the respective standard threaded hole while the controller components are operated in a close state.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a sectional view of the screwless fixing apparatus according to the preferred embodiment of the present invention.

FIG. 2 is a exploded view of the screwless fixing apparatus in the present invention.

FIG. 3 is a schematic view showing the screwless fixing apparatus when installing the disk drive.

FIG. 4 is a schematic view showing the screwless fixing apparatus when disassembling the disk drive.

### DETAILED DESCRIPTION OF THE PREFERRED EMBODIMENT

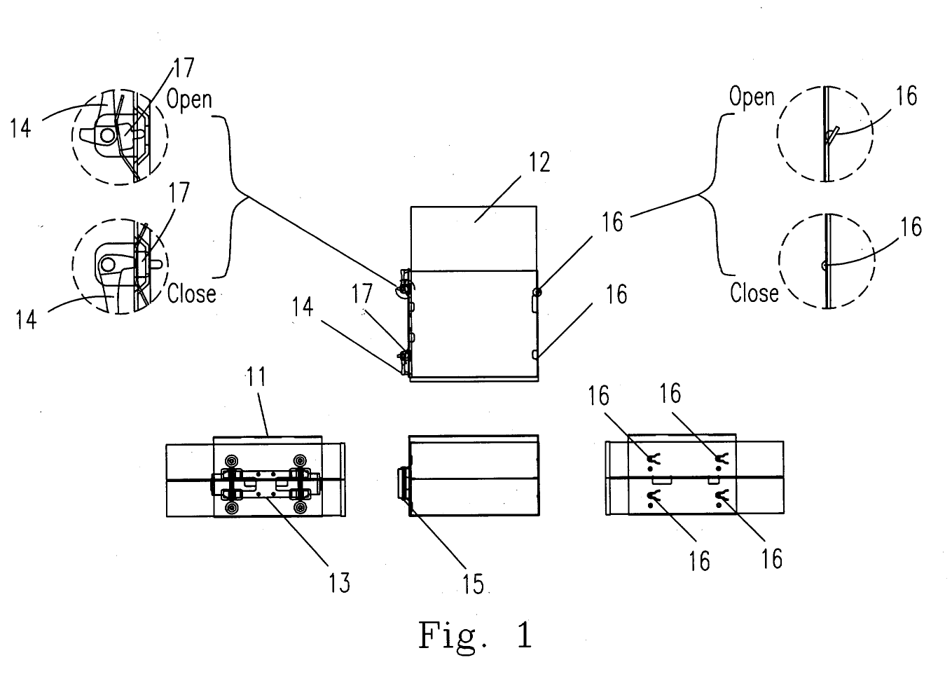

As shown in FIG. 1, the preferred embodiment of the present invention provides a screwless fixing apparatus of the disk drive for fixing the disk drive 12 to the computer case. The fixing apparatus includes a frame 11, a plurality of folding teeth 16, a plurality of the elastic protruding components 17, and a plurality of controller components 14. The frame 11 has two sides with a plurality of standard threaded holes for containing the disk drive. The plurality of folding teeth 16 are mounted on the first side of the frame 11 and combined with the frame by means of one of riveting and soldering for engaging with a plurality of the standard threaded holes on the corresponding side of the disk drive 12. The plurality of the elastic protruding components 17 are mounted on the second opposite side of the frame 11 for engaging with a plurality of the standard threaded holes on the corresponding side of the disk drive 12. And, the plurality of controller components 14, set in the outsides of the plurality of the, elastic protruding components 17 and mounted on the frame 11 by an axle center 15 for controlling the fastening switches of the elastic protruding components by means of rotating the controller components.

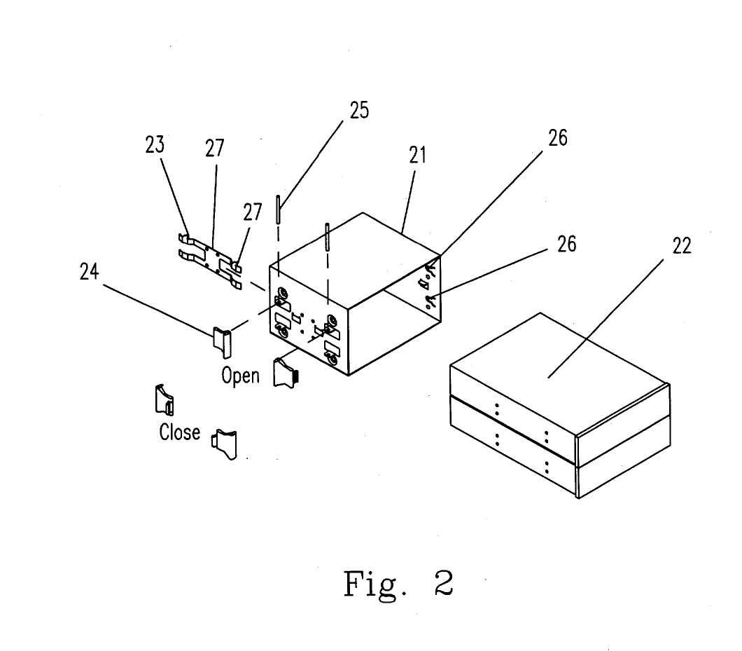

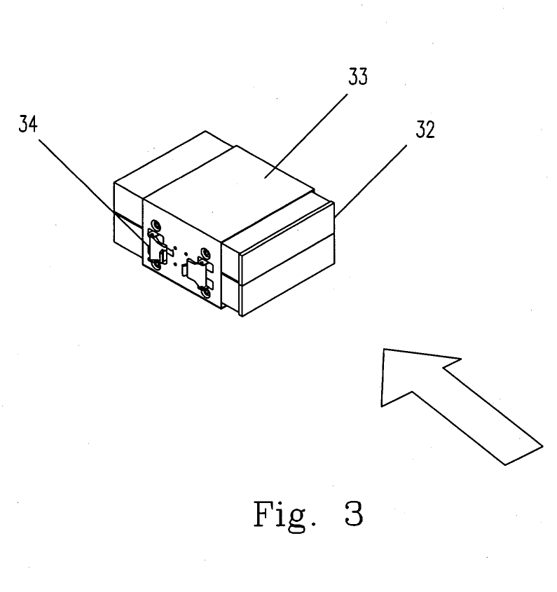

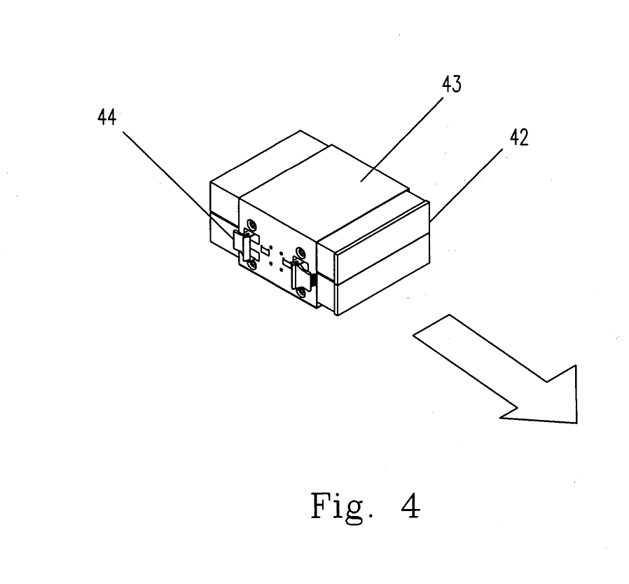

FIG. 2 is a exploded view according to the preferred embodiment of the present invention. FIG. 3 and FIG. 4 shows respectively the illustration of assembling and disassembling configurations according to the preferred embodiment of the present invention. When installing a disk drive 22 in a computer case, first, operate the controller components 24 of the screwless fixing apparatus in open state and the elastic protruding components 27 bounce automatically. Second, put the disk drive 22 into the frame 21 till one feels the disk drive 22 is in position. Third, operate the controller components 24 in close state, in the same time, the elastic protruding components 27 mounted on the left side of the frame 21 engage with the respective standard threaded holes. Last, operate one switch of the folding teeth 26 in close state so that the folding teeth 26 engage with the standard threaded holes of the disk drive 22 and the disk drive 22 is fixed efficiently. When disassembling the disk drive 22, operate one switch of the folding teeth 26 mounted on the right side of the frame 21 in open state. Because the force of pressing the folding teeth 26 is removed, the folding teeth 26 bounce by elastic force themselves and are out of the standard threaded holes. Then operate the controller components 24 of the screwless fixing apparatus in open state, the elastic protruding components 27 bounce automatically and the disk drive 22 can be removed. It is very convenient and simple to operate the screwless fixing apparatus for fixing the disk drive.

When utilizing the screwless fixing apparatus of the present invention for fixing the disk drive to the computer case, it only needs to operate the controller components in open state. After the disk drive is in position, operate the controller components in close state and the disk drive is fixed efficiently. By the same way, when disassembling the disk drive, operate the controller components of the screwless fixing apparatus in open state and the disk drive can be took out very simply. The present invention provides a convenient fixing apparatus for fixing the disk drive having the standard threaded holes without screws. The application is truly an invention hard to come by.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A screwless fixing apparatus for fixing a disc drive having a plurality of standard threaded holes on two sides thereof in a computer case, comprising:
a frame for containing said disc drive;
a plurality of elastic pieces mounted on a first side of said frame for respectively engaging with a plurality of standard threaded holes on the corresponding first side of said disc drive;
a plurality of elastic protruding components mounted on a second opposite side of said frame for engaging with a plurality of standard threaded holes on the corresponding second side of said disc drive; and
a plurality of controller components mounted separately outside of said plurality of elastic protruding components for controlling fastening switches of said elastic protruding components by means of rotating said controller components.

2. The screwless fixing apparatus according to claim 1 wherein said plurality of elastic pieces are combined with said frame by means of one of riveting and soldering.

3. The screwless fixing apparatus according to claim 1 wherein each of said elastic pieces further comprises a folding tooth for engaging with said respective standard threaded hole.

4. The screwless fixing apparatus according to claim 1 wherein each of said elastic protruding components further comprises a fastening part for engaging with said respective standard threaded hole.

5. The screwless fixing apparatus according to claim 1 wherein each of said plurality of elastic protruding components further comprises a fastening switch for engaging with said plurality of standard threaded holes of said disc drive.

6. The screwless fixing apparatus according to claim 1 wherein each of said controller components further comprises an axle center, a rotating piece and a protruding part.

7. The screwless fixing apparatus according to claim 6 wherein said protruding part presses said fastening part of said respective elastic protruding component to engage with said respective standard threaded hole while said controller components are operated in a close state.
